(19) United States
(12) Patent Application Publication
(10) Pub. No.: US 2024/0213732 A1
(43) Pub. Date: Jun. 27, 2024

(54) JIG FOR ASSEMBLING CONNECTOR ASSEMBLY

(71) Applicant: MOLEX, LLC, Lisle, IL (US)

(72) Inventors: Ya-Li Xu, New Taipei City (TW); Che-Yuan Yang, New Taipei City (TW)

(21) Appl. No.: 18/515,328

(22) Filed: Nov. 21, 2023

(30) Foreign Application Priority Data
Dec. 26, 2022 (CN) 202211677356.X

(51) Int. Cl. H01R 43/20

(52) U.S. Cl. CPC H01R 43/205

(57) ABSTRACT

A jig for assembling a connector assembly is proposed. The connector assembly includes a guide shielding cage and a heat sink which has been assembled on the guide shielding cage, the guide shielding cage includes two side walls which each have a pressed protrusion. The jig includes a pressing cover, two movable plates and a supporting spring. Each movable plate has a connecting portion disposed at an upper portion thereof, a pushed portion disposed below the connecting portion, and an acting construction w disposed below the pushed portion, the pressing cover is assembled with the connecting portions of the two movable plates in a manner that the pressing cover is capable of moving up and down relative to the two movable plates, the two movable plates are arranged laterally and are capable of moving between an unloading state where the two movable plates are away from each other and a loading state where the two movable plates are close to each other, the acting construction has a gripping portion which is inward and a pressing portion which is downward. The supporting spring is provided between the two movable plates. The pressing cover which is pressed downwardly is capable of pushing the pushed portions, so as to make the two movable plates move inwardly toward each other from the unloading state to the loading state, the gripping portions of the two movable plates inwardly grip the two side walls of the guide shielding cage respectively, the pressing portions of the two movable plates downwardly press on the pressed protrusions of the two side walls of the guide shielding cage respectively.

### RELATED APPLICATION

The present application claims priority to Chinese patent application no. 202211677356.X filed on Dec. 26, 2022, which is incorporated by reference in its entirety.

### TECHNICAL FIELD

The present disclosure relates to a jig, and particularly relates to a jig for assembling a connector assembly.

### BACKGROUND

U.S. Pat. No. 5,896,649 discloses an assembling tool which is used to mount a connector onto a circuit board, the connector includes a plurality of terminals, each terminal has a board inserting leg which extends out of a board mounting face of the connector, the board inserting leg of the terminal has a compliant structure (for example needle eye pin), the assembling tool includes one pressing plate which is a solid metal, the pressing plate presses a top surface of the connector from up to down to press the board inserting legs of the plurality of terminals into through holes of the circuit board with interference engagement.

When a guide shielding cage with a heat sink on a top surface of the guide shielding cage is assembled to a circuit board, it generally also employs a pressing plate as disclosed in the above prior art to assist assembling, such a pressing plate is downwardly pressed on the top surface of the heat sink to press inserting legs (for example compliant pins or needle eye pins) at a bottom portion of the guide shielding cage into through holes of the circuit board with interference engagement.

However, not all the heat sinks are capable of bearing the pressing force of the pressing plate, some of heat sinks (for example the heat sink having dissipating fins which each are thin sheet shaped) cannot bear the pressing force, when the pressing plate is pressed on the heat sink, it may make the dissipating fins of the heat sink to be deformed or damaged. Moreover, a position of the pressing plate is on a top surface of the heat sink, a distance from the pressing plate to the inserting legs of the guide shielding cage is larger, when the pressing force of the pressing plate is off-balance, the inserting leg is prone to offset relative to the through hole of the circuit board, which causes distort deformation of the inserting leg so that the inserting leg cannot be inserted into or is only partially inserted into the through hole of the circuit board, and in turn causes the assembling operation to be failed.

### SUMMARY

Therefore, an object of the present disclosure is to provide a jig for assembling a connector assembly which can overcome at least one deficiency of the prior art.

Accordingly, a jig for assembling a connector assembly of the present disclosure is provided, the connector assembly comprises a guide shielding cage and a heat sink which has been assembled on the guide shielding cage, the guide shielding cage comprises two side walls which each have a pressed protrusion. The jig comprises a pressing cover, two movable plates and a supporting spring. Each movable plate has a connecting portion disposed at an upper portion thereof, a pushed portion disposed below the connecting portion, and an acting construction disposed below the pushed portion, the pressing cover is assembled with the connecting portions of the two movable plates in a manner that the pressing cover is capable of moving up and down relative to the two movable plates, the two movable plates are arranged laterally and are capable of moving between an unloading state where the two movable plates are away from each other and a loading state where the two movable plates are close to each other, the acting construction has a gripping portion which is inward and a pressing portion which is downward. The supporting spring is provided between the two movable plates. When the jig is provided to the connector assembly, the pressing cover which is pressed downwardly is capable of pushing the pushed portions, so as to make the two movable plates move inwardly toward each other relative to the pressing cover from the unloading state to the loading state, and make the supporting spring compressed, the gripping portions of the two movable plates inwardly grip the two side walls of the guide shielding cage respectively, the pressing portions of the two movable plates downwardly press on the pressed protrusions of the two side walls of the guide shielding cage respectively.

In some embodiments, the pressing cover has two side plates, the two movable plates are assembled to inner side surfaces of the two side plates, in the unloading state, the two side plates of the pressing cover are positioned above the pushed portions of the two movable plates respectively, the supporting spring makes the two movable plates respectively outwardly abut against the inner side surfaces of the two side plates of the pressing cover respectively; in the loading state, the pressing cover is pressed downwardly to move downwardly relative to the movable plate, lower edges of the two side plates of the pressing cover push the two movable plates along the pushed portions of the two movable plates respectively to make the two movable plates move inwardly toward each other and be close to each other, and make the supporting spring compressed.

In some embodiments, each side plate of the pressing cover has a guiding hole which extends up and down, the connecting portion of each movable plate has a through hole, the jig further comprises a supporting rod which passes through the guiding holes of the two side plates and the through holes of the connecting portions of the two movable plates, the guiding holes of the pressing cover are capable of moving up and down relative to the supporting rod, the two movable plates are capable of moving laterally along the supporting rod, the supporting spring sheathes the supporting rod and is provided between the two movable plates.

In some embodiments, each movable plate further has an operation handle, the pressing cover has operation handle avoiding holes, the operation handle outwardly pass through the operation handle avoiding holes respectively to allow to be operated so as to make the two movable plates move relative to the pressing cover.

In some embodiments, the pushed portion is in form of pushed oblique surface construction which obliquely extends downwardly and outwardly and is formed to an outer side surface of the movable plate.

In some embodiments, a width of the heat sink of the connector assembly in a lateral direction is larger than a width of the guide shielding cage in the lateral direction, in the unloading state, a width between the acting constructions of the two movable plates of the jig is larger than the width of the heat sink in the lateral direction.

In some embodiments, the acting construction obliquely extend inwardly and downwardly from a lower portion of the movable plate.

In some embodiments, the pressed protrusion comprises a plurality of bulges which are integrally constructed on the corresponding side wall and are arranged front and rear as a column, in the loading state, the pressing portions of the two movable plates press downwardly on the bulges of the two side walls of the guide shielding cage.

In some embodiments, the guide shielding cage further has a plurality of inserting legs which are positioned to a bottom edge of the corresponding side wall, the plurality of bulges are positioned to a lower half portion of the corresponding side wall and are close to the plurality of inserting legs, in the loading state, the pressing portions of the two movable plates press downwardly on the bulges of the two side walls of the guide shielding cage to make the inserting legs of the two side walls of the guide shielding cage downwardly inserted into a circuit board.

In some embodiments, the pressing cover has a front positioning piece which is integrally constructed to a front end of the pressing cover and extends downwardly and two side positioning pieces which are integrally constructed at two sides of the pressing cover, are close to the front end of the pressing cover and extend downwardly, the front positioning piece is capable of being positioned at a front end of the guide shielding cage, the two side positioning pieces are capable of being positioned at two sides of the heat sink.

In some embodiments, the movable plate further has a guiding block which extends inwardly from an inner side surface of the movable plate, the pressing cover has an inner top surface and an inner boss which extends downwardly from the inner top surface, the inner boss has guiding grooves which are positioned to two sides of the inner boss and each accommodate the corresponding guiding block.

In the present disclosure, the jig for assembling the connector assembly is capable of gripping the guide shielding cage with the heat sink to move together, meanwhile the jig directly presses on the pressed protrusions of the two side walls of the guide shielding cage, so as to press the guide shielding cage, which has been assembled thereon with the heat sink, to assemble the guide shielding cage onto the circuit board. Furthermore, the jig does not press on the heat sink, so as to avoid the heat sink being damaged. Additionally, because the two movable plates of the jig are capable of passing the heat sink, which is larger in width, from up to down and are placed at the outer sides of the two side walls of the guide shielding cage, the jig of the present disclosure is capable of being adapted to combination the heat sink, which has various wider widths and the guide shielding cage. Moreover, a position of the pressed protrusion pressed by the jig is positioned to the lower half portion of the corresponding side wall and is close to the inserting legs, transferring an acting force from the pressing is more direct and a transfer path is short, which can make the inserting leg correctly aligned with and inserted into the corresponding through hole of the circuit board 300, avoid distort deformation of the inserting leg.

### BRIEF DESCRIPTION OF THE DRAWINGS

Other features and effects of the present disclosure will be apparent from an embodiment with reference to the drawings, in which:

FIG. 1 is a perspective view of an embodiment of a jig for assembling a connector assembly of the present disclosure, in which a circuit board provided with a receptacle connector and being to be assembled with a connector assembly is also shown;

FIG. 2 is a perspective exploded view of the jig and the connector assembly;

FIG. 3 is a perspective exploded view of the jig;

FIG. 4 is a perspective view illustrating that the jig is provided to the connector assembly, in which a pressing cover of the jig is not pressed downwardly relative to two movable plates and the two movable plates are in an unloading state;

FIG. 5 is a side view illustrating that the jig is provided to the connector assembly, in which the pressing cover of the jig is not pressed downwardly relative to the two movable plates and the two movable plates are in the unloading state;

FIG. 6 is a cross sectional view taken along a line A-A of FIG. 5;

FIG. 7 is a perspective view similar to FIG. 4, in which the jig of the pressing cover is pressed downwardly relative to the two movable plates and the two movable plates in a loading state;

FIG. 8 is a cross sectional view similar to FIG. 6, in which the jig of the pressing cover is pressed downwardly relative to the two movable plates and the two movable plates in the loading state.

### DETAILED DESCRIPTION

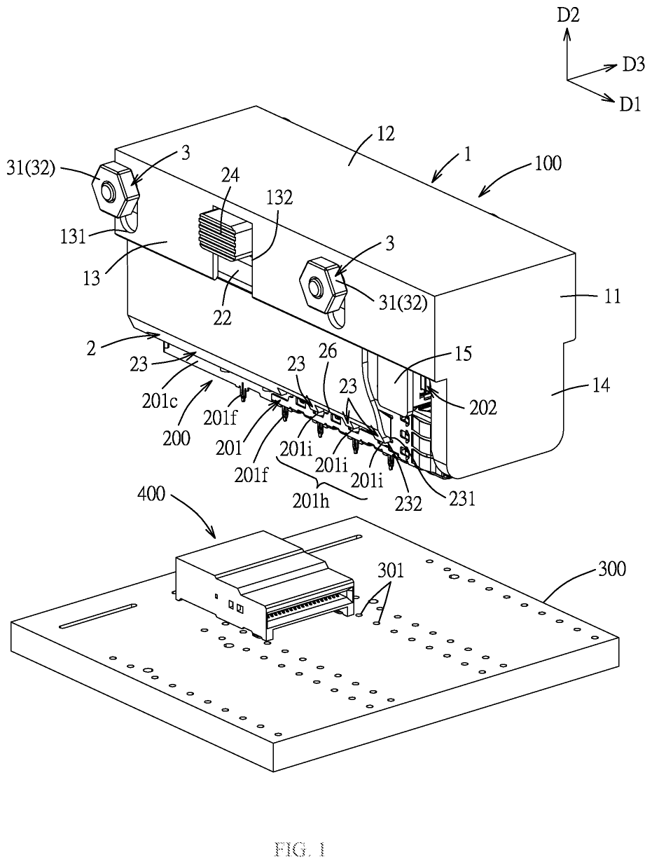

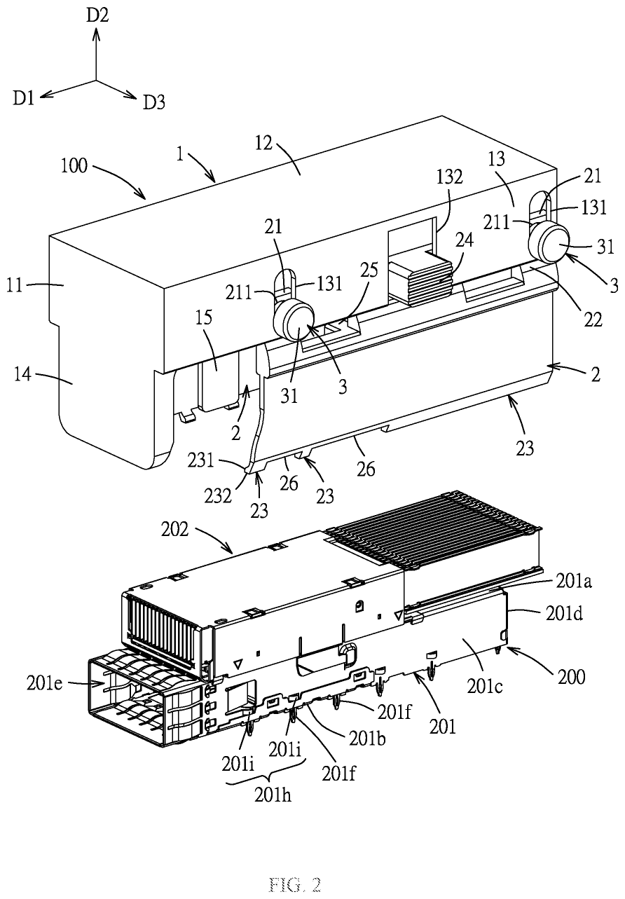

Referring to FIG. 1 to FIG. 3, an embodiment of a jig 100 for assembling a connector assembly 200 of the present disclosure includes a pressing cover 1, two movable plates 2, two supporting rods 3 and two supporting springs 4.

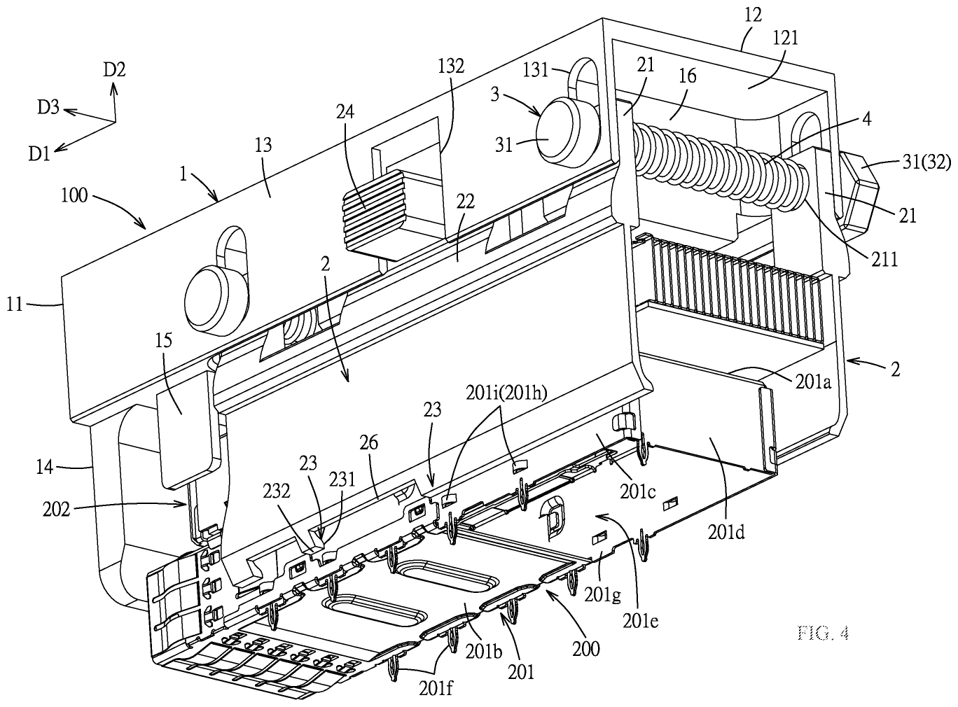

The connector assembly 200 includes a guide shielding cage 201 and a heat sink 202 which has been assembled on the guide shielding cage 201. The guide shielding cage 201 extends along a front-rear direction D1 (a direction to which an arrow points is front, and an opposite direction is rear), and includes a top wall 201a which allows the heat sink 202 to be assembled thereon, a bottom wall 201b which faces the top wall 201a along an up-down direction D2 (a direction to which an arrow points is up, and an opposite direction is down), two side walls 201c which are connected between the top wall 201a and the bottom wall 201b and face each other in a left-right direction D3 (a direction to which an arrow points is right, and an opposite direction is left), a rear wall 201d which is connected to a rear edge of the top wall 201a and rear edges of the two side walls 201c, an inserting passageway 201e which is defined together by the top wall 201a, the bottom wall 201b, the two side walls 201c and the rear wall 201d, and a plurality of inserting legs 201f which are positioned to bottom edges of the two side walls 201c. For example, the plurality of inserting legs 201f are used to be mounted in a plurality of inserting holes 301 of a substrate of a circuit board 300 so as to be connected to a grounding trace (not shown). For example, the plurality of inserting legs 201f may be but is not limited to compliant pins, for example may be needle eye pins. The plurality of inserting legs 201f are configured to be used to interferingly press into the plurality of inserting holes 301 of the circuit board 300 respectively and be electrically connected with the grounding trace. The circuit board 300 has been assembled with a receptacle connector 400, after the connector assembly 200 is assembled to the circuit board 300, the receptacle connector 400 is received in the inserting passageway 201e via a bottom opening 201g (see FIG. 4) of the inserting passageway 201e.

The two side walls 201c of the guide shielding cage 201 each have a pressed protrusion 201h which is disposed at a lower half portion of the corresponding side wall 201c and is close to the corresponding inserting leg 201f at a bottom portion of the corresponding side wall 201c. The pressed protrusion 201h of each side wall 201c includes a plurality of bulges 201i which are integrally constructed on the side wall 201c and are arranged front and rear as a column, the plurality of bulges 201i are positioned to the lower half portion of the side wall 201c and are close to the plurality of inserting legs 201f. Additionally, a width of the heat sink 202 of the connector assembly 200 in a lateral direction (i.e., the left-right direction ) is larger than a width of the guide shielding cage 201 in the lateral direction.

The pressing cover 1 of the jig 100 extends along the front-rear direction D1, and has a front end portion 11, a top plate 12 which extends rearwardly from the front end portion 11 and has an inner top surface 121 which is downward, two side plates 13 which extend downwardly from the top plate 12 along the up-down direction D2 and face each other in the left-right direction D3, a front positioning piece 14 which is integrally constructed to the front end portion 11 and extends downwardly, two side positioning pieces 15 which are integrally constructed at two sides of the front end portion 11 respectively and extend downwardly, and an inner boss 16 which extends downwardly from the inner top surface 121 of the top plate 12. Each side plate 13 of the pressing cover 1 has two guiding holes 131 which extend up and down, are in form of elongated structure and are arranged front and rear, and an operation handle avoiding hole 132 which is positioned between the two guiding holes 131. The front positioning piece 14 can be positioned at a front end of the guide shielding cage 201, the two side positioning pieces 15 can be positioned at two sides of the heat sink 202. The inner boss 16 has a plurality of guiding grooves 161 which are positioned to a left side and a right side of the inner boss 16.

The two movable plates 2 each are in form of plate body which extends in the front-rear direction D1 and the up-down direction D2, and the two movable plates 2 are arranged laterally along the left-right direction D3 and are respectively assembled to inner side surfaces of the two side plates 13 of the pressing cover 1. Each movable plate 2 has two connecting portions 21 which are disposed at an upper portion of the movable plate 2 and are arranged along the front-rear direction D1, a pushed portion 22 which is disposed below the two connecting portions 21, a plurality of acting constructions 23 which are positioned below the pushed portion 22 and are arranged along the front-rear direction D1, an operation handle 24 which is disposed between the two connecting portions 21 and outwardly passes through the operation handle avoiding hole 132, and a plurality of guiding blocks 25 which extend inwardly from an inner side surface of the movable plate 2 and are used to be correspondingly accommodated in the guiding grooves 161 of the inner boss 16. Each connecting portion 21 is positioned to an inner side of the two side plates 13 of the pressing cover 1 and has a through hole 211 which is formed along the left-right direction D3. The pushed portion 22 is in form of pushed oblique surface construction which obliquely extends downwardly and outwardly and is formed to an outer side surface of the movable plate 2.

Each acting construction 23 obliquely extends inwardly and downwardly from a lower portion of the movable plate 2, and each acting construction 23 has a gripping portion 231 which is inward and is used to grip the guide shielding cage 201, and a pressing portion 232 which is downward and is used to press the corresponding bulge 201i of the pressed protrusion 201h of the guide shielding cage 201. In the present embodiment, each movable plate 2 has several acting constructions 23 which are positioned in the front of the movable plate 2 and are short (the several acting constructions 23 are two acting constructions 23 with respect to the movable plate 2 at the right, the several acting constructions 23 are three acting constructions 23 with respect to the movable plate 2 at the left), and one acting construction 23 which is positioned behind the several acting constructions 23 and is long, the several acting constructions 23 which are short are used to each press one corresponding bulge 201i, the one acting construction 23 which is behind the several acting constructions 23 and is long is used to meanwhile press the two or more corresponding bulges 201i, and the plurality of acting constructions 23 are formed therebetween with avoiding recesses 26 which are used to avoid some constructions on the corresponding side wall 201c of the guide shielding cage 201 (for example latching constructions between the bottom wall 201b and the two side walls 201c). But in other implementing manners, each movable plate 2 also may only have one acting construction 23.

Each supporting rod 3 has two enlarged end portions 31 which are positioned to a left side and a right side of the supporting rod 3 and abut against outer side surfaces of the two side plates 13 of the pressing cover 1 respectively, one enlarged end portion 31 of the two enlarged end portions 31 may be a nut 32. Each supporting rod 3 passes through the corresponding guiding holes 131 of the two side plates 13 and the through holes 211 of the corresponding connecting portions 21 of the two movable plates 2, so as to assemble the two movable plates 2 to the inner side of the two side plates 13. Because the guiding holes 131 of the pressing cover 1 are limited to move in the front-rear direction D1 and the left-right direction D3 by the two supporting rods 3, the guiding holes 131 of the pressing cover 1 basically only can move in the up-down direction D2 relative to the two supporting rods 3, that is, the pressing cover 1 only can move in the up-down direction D2 relative to the two movable plates 2. Movement of the two movable plates 2 in the up-down direction D2 and the front-rear direction D1 is limited by the two supporting rods 3, basically, the two movable plates 2 only can move laterally along the two supporting rods 3 (along the left-right direction D3), that is to say, the two movable plates 2 only can move inwardly or move outwardly relative to the pressing cover 1 along the left-right direction D3.

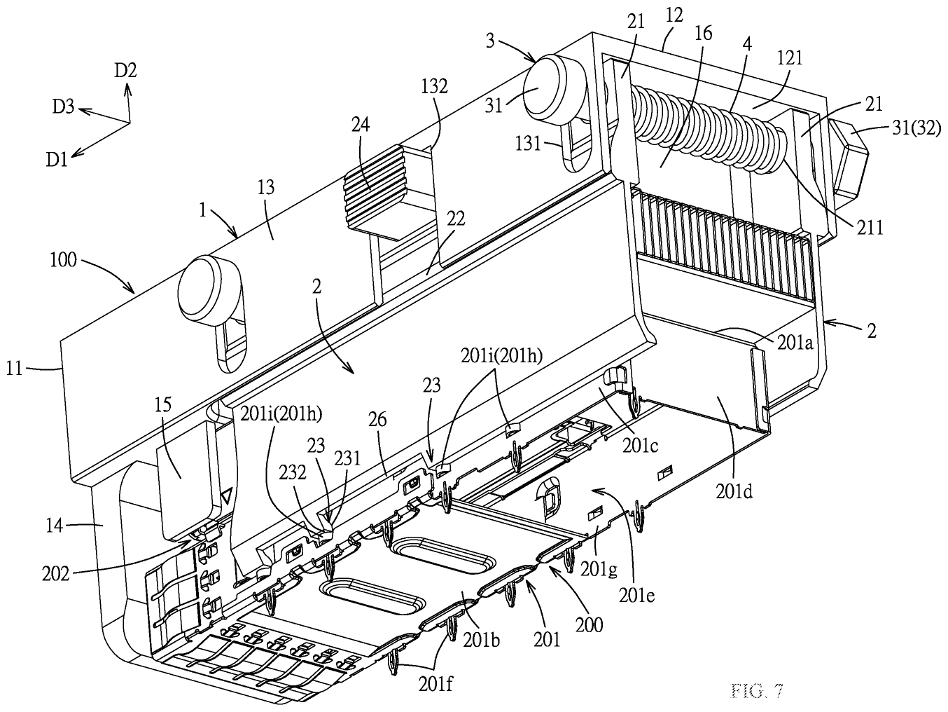

With the two supporting rods 3, the pressing cover 1 is assembled with the connecting portions 21 of the two movable plates 2 in a manner that the pressing cover 1 is capable of moving up and down relative to the two movable plates 2 and making that the two movable plates 2 are capable of moving between an unloading state (see FIG. 4) where the two movable plates 2 are away from each other and a loading state (see FIG. 7) where the two movable plates 2 are close to each other.

The two supporting springs 4 for example but are not limited to coil springs, the two supporting springs 4 sheathe the two supporting rods 3 respectively and are provided between the two movable plates 2, two ends of each supporting spring 4 elastically abut against the inner side surfaces of the two movable plates 2 respectively, and are used to drive the two movable plates 2 to be away from each other by means of an elastic acting force of the supporting spring 4, and to make that the two movable plates 2 have tendency to be in the unloading state by means of the elastic acting forces of the two supporting springs 4.

Hereinafter how to assemble the guide shielding cage 201 (the connector assembly 200) which has been assembled thereon with the heat sink 202 onto the circuit board 300 by using the jig 100 is described.

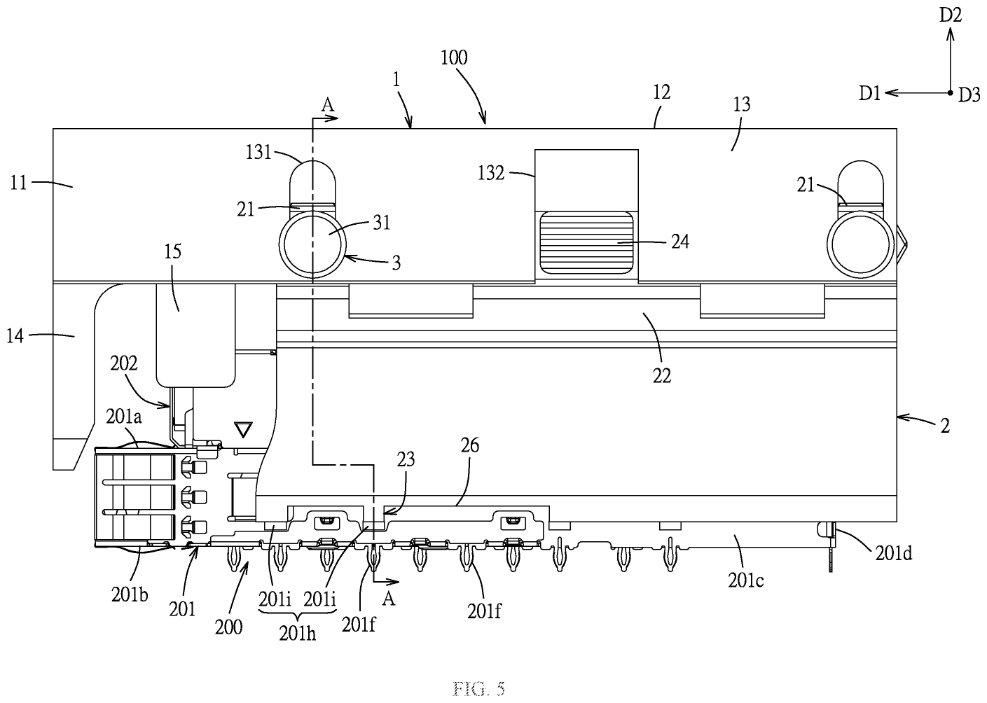

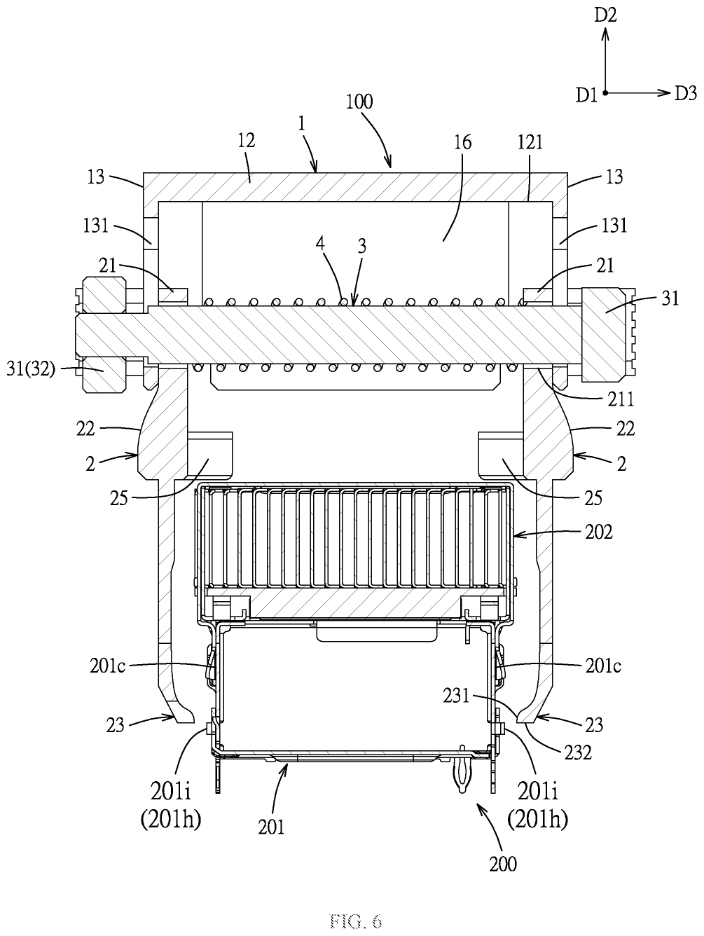

Referring to FIG. 4 to FIG. 6, firstly, the two movable plates 2 of the jig 100 is in the unloading state, in this state, lower edges of the two side plates 13 of the pressing cover 1 are positioned above the pushed portions 22 of the two movable plates 2, and the two supporting rods 3 are positioned to lower ends of the guiding holes 131 of the pressing cover 1, the two supporting springs 4 make the two movable plates 2 to splay outwardly along the left-right direction D3 and make the connecting portions 21 of the two movable plates 2 outwardly abut against the inner side surfaces of the two side plates 13 of the pressing cover 1 in the left-right direction D3 respectively. At this time, a width between the acting constructions 23 of the two movable plates 2 of the jig 100 is larger than the width of the heat sink 202 in the lateral direction, so that the two movable plates 2 of the jig 100 are capable of pass the heat sink 202, which is larger in width, from up to down and are capable of being placed at a left outer side and a right outer side of the two side walls 201c of the guide shielding cage 201 so as to provide the jig 100 to the connector assembly 200, at this time, the guiding blocks 25 of the two movable plates 2 for example may seat on the heat sink 202 to function as pre-supporting the jig 100, at this time the pressing portions 232 of the acting constructions 23 of the two movable plates 2 may be lower than the bulges 201i. At this time, the front positioning piece 14 of the pressing cover 1 is capable of being positioned at the front end of the guide shielding cage 201, the two side positioning pieces 15 of the pressing cover 1 are capable of being positioned at the two sides of the heat sink 202 respectively, thereby helping positioning and assembling of the jig 100 to make that the jig 100 can rapidly and correctly perform assembling.

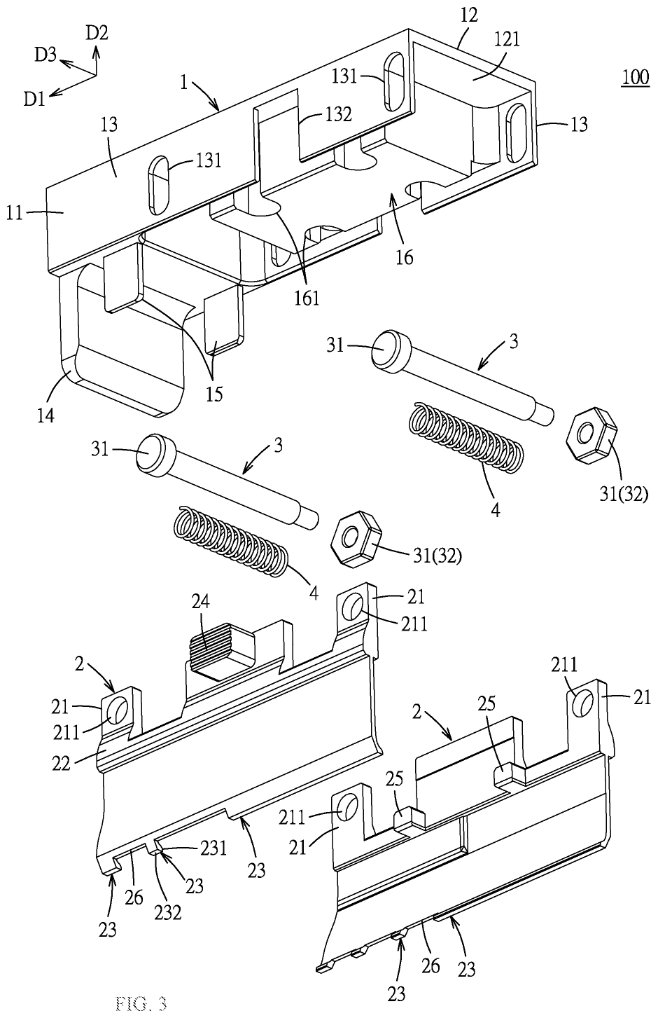

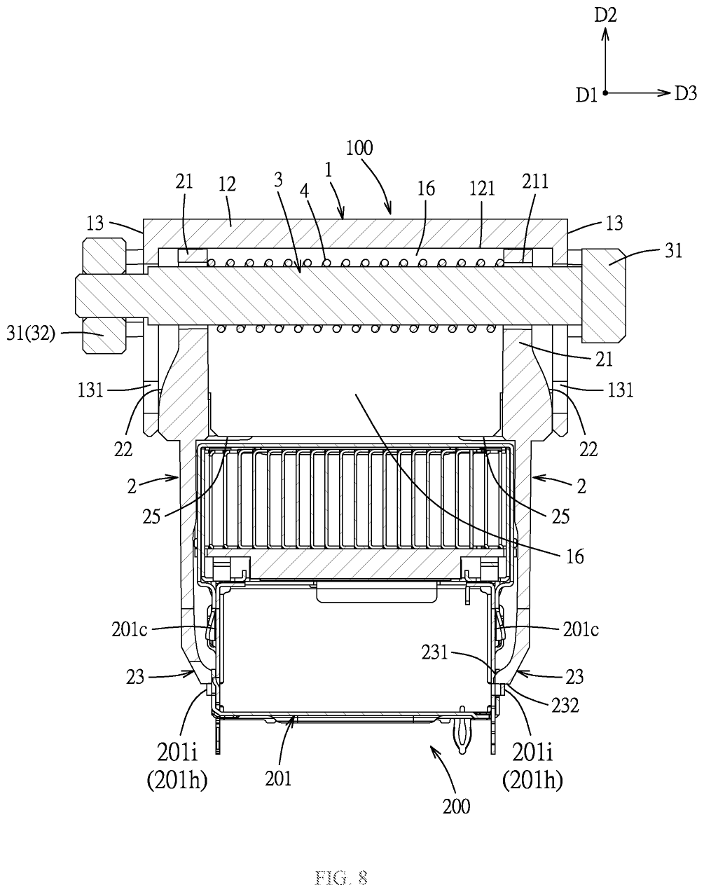

Referring to FIG. 3 and FIG. 7 to FIG. 8, next, the pressing cover 1 is pressed downwardly to make the pressing cover 1 move downwardly relative to the two movable plates 2, the guiding holes 131 of the pressing cover 1 move downwardly along the two supporting rods 3, the lower edges of the two side plates 13 of the pressing cover 1 push the pushed portions 22 of the two movable plates 2 inwardly along the pushed portions 22 of the two movable plates 2 along the left-right direction D3, so as to make the two movable plates 2 move inwardly toward each other and be close to each other relative to the pressing cover 1 from the unloading state to the loading state, and make the supporting spring 4 compressed. In the loading state, the two supporting rods 3 are positioned to upper ends of the guiding holes 131 of the pressing cover 1, the gripping portions 231 of the acting constructions 23 of the two movable plates 2 inwardly grip the two side walls 201c of the guide shielding cage 201 respectively, the pressing portions 232 of the acting constructions 23 of the two movable plates 2 move upwardly and inwardly onto the bulges 201i of the pressed protrusions 201h of the two side walls 201c of the guide shielding cage 201, meanwhile lift each guiding block 25 to leave the heat sink 202, each guiding groove 161, which moves downwardly, of the inner boss 16 receives the corresponding guiding block 25 and also has guiding function. In the loading state, both a bottom surface of the boss 16 and each guiding block 25 do not contact the heat sink 202.

It is noted that, in some cases, the operation handle 24 may be pushed to make the two movable plates 2 move relative to the pressing cover 1. For example, when the jig 100 is upside down up and down loaded to the guide shielding cage 201 with the heat sink 202, because the pressing cover 1 is placed on a table surface and cannot be pressed and cannot move relative to the two movable plates 2, at this time, the operation handles 24, which outwardly pass through the operation handle avoiding holes 132 of the two movable plates 2 respectively, may be operated and be pushed, so as to make the two movable plates 2 move relative to the pressing cover 1 and grip the guide shielding cage 201.

Referring to FIG. 1 and FIG. 7 to FIG. 8, in the loading state, the jig 100 is capable of stably gripping the guide shielding cage 201 with the heat sink 202 to move together, when the guide shielding cage 201 with the heat sink 202 is assembled to the circuit board 300, the pressing cover 1 continues to be further pressed downwardly by a tool or a machine (not shown), the pressing portions 232 of the two movable plates 2 press each bulge 201i of the two side walls 201c of the guide shielding cage 201 downwardly, so as to make the plurality of inserting legs 201f of the guide shielding cage 201 interferingly pressed into the plurality of inserting holes 301 of the circuit board 300 and make the plurality of inserting legs 201f downwardly inserted into the circuit board 300. In this process, the jig 100 is capable of stably gripping the guide shielding cage 201 with the heat sink 202 to move together, when the connector assembly 200 is assembled to the circuit board 300, the jig 100 directly presses on the pressed protrusions 201h of the side walls 201c of the guide shielding cage 201, and the inner boss 16 of the pressing cover 1 and the heat sink 202 do not contact each other, so that the jig 100 does not press on the heat sink 202 to avoid the heat sink 202 being damaged.

After the connector assembly 200 is successfully assembled to the circuit board 300, the pressing cover 1 may be reversely operated so as to make the two movable plates 2 move to the unloading state, and then the jig 100 is unloaded.

In conclusion, in the present disclosure, the jig 100 for assembling the connector assembly 200 is capable of gripping the guide shielding cage 201 with the heat sink 202 to move together, meanwhile the jig 100 directly presses on the pressed protrusions 201h of the two side walls 201c of the guide shielding cage 201, so as to press the guide shielding cage 201, which has been assembled thereon with the heat sink 202, to assemble the guide shielding cage 201 onto the circuit board 300. Furthermore, the jig 100 does not press on the heat sink 202, so as to avoid the heat sink 202 being damaged. Additionally, because the two movable plates 2 of the jig 100 are capable of passing the heat sink 202, which is larger in width, from up to down and are placed at the outer sides of the two side walls 201c of the guide shielding cage 201, the jig 100 of the present disclosure is capable of being adapted to combination the heat sink 202, which has various wider widths and the guide shielding cage 201. Moreover, a position of the pressed protrusion 201h pressed by the jig 100 is positioned to the lower half portion of the corresponding side wall 201c and is close to the inserting legs 201f, transferring an acting force from the pressing is more direct and a transfer path is short, which can make the inserting leg 201f correctly aligned with and inserted into the corresponding through hole 211 of the circuit board 300, avoid distort deformation of the inserting leg 201f.

However, the above description is only for the embodiments of the present disclosure, and it is not intended to limit the implementing scope of the present disclosure, and the simple equivalent changes and modifications made according to the claims and the contents of the specification are still included in the scope of the present disclosure.

What is claimed is:

1. A jig for assembling a connector assembly,
the connector assembly comprising a guide shielding cage and a heat sink which has been assembled on the guide shielding cage, the guide shielding cage comprising two side walls which each have a pressed protrusion,
the jig comprising:
a pressing cover;
two movable plates, each movable plate having a connecting portion disposed at an upper portion thereof, a pushed portion disposed below the connecting portion, and an acting construction disposed below the pushed portion, the pressing cover being assembled with the connecting portions of the two movable plates in a manner that the pressing cover is capable of moving up and down relative to the two movable plates, the two movable plates being arranged laterally and being capable of moving between an unloading state where the two movable plates are away from each other and a loading state where the two movable plates are close to each other, the acting construction having a gripping portion which is inward and a pressing portion which is downward;
and
a supporting spring which is provided between the two movable plates;
when the jig is provided to the connector assembly, the pressing cover which is pressed downwardly being capable of pushing the pushed portions, so as to make the two movable plates move inwardly toward each other relative to the pressing cover from the unloading state to the loading state, and make the supporting spring compressed, the gripping portions of the two movable plates inwardly gripping the two side walls of the guide shielding cage respectively, the pressing portions of the two movable plates downwardly pressing on the pressed protrusions of the two side walls of the guide shielding cage respectively.

2. The jig for assembling the connector assembly of claim 1, wherein
the pressing cover has two side plates,
the two movable plates are assembled to inner side surfaces of the two side plates,
in the unloading state, the two side plates of the pressing cover are positioned above the pushed portions of the two movable plates respectively, the supporting spring makes the two movable plates respectively outwardly abut against the inner side surfaces of the two side plates of the pressing cover respectively;
in the loading state, the pressing cover is pressed downwardly to move downwardly relative to the movable plate, lower edges of the two side plates of the pressing cover push the two movable plates along the pushed portions of the two movable plates respectively to make the two movable plates move inwardly toward each other and be close to each other, and make the supporting spring compressed.

3. The jig for assembling the connector assembly of claim 2, wherein
each side plate of the pressing cover has a guiding hole which extends up and down,
the connecting portion of each movable plate has a through hole,
the jig further comprises a supporting rod which passes through the guiding holes of the two side plates and the through holes of the connecting portions of the two movable plates,
the guiding holes of the pressing cover are capable of moving up and down relative to the supporting rod,
the two movable plates are capable of moving laterally along the supporting rod,
the supporting spring sheathes the supporting rod and is provided between the two movable plates.

4. The jig for assembling the connector assembly of claim 3, wherein
each movable plate further has an operation handle,
the pressing cover has operation handle avoiding holes,
the operation handle outwardly pass through the operation handle avoiding holes respectively to allow to be operated so as to make the two movable plates move relative to the pressing cover.

5. The jig for assembling the connector assembly of claim 2, wherein
the pushed portion is in form of pushed oblique surface construction which obliquely extends downwardly and outwardly and is formed to an outer side surface of the movable plate.

6. The jig for assembling the connector assembly of claim 1, wherein
a width of the heat sink of the connector assembly in a lateral direction is larger than a width of the guide shielding cage in the lateral direction,
in the unloading state, a width between the acting constructions of the two movable plates of the jig is larger than the width of the heat sink in the lateral direction.

7. The jig for assembling the connector assembly of claim 6, wherein
the acting construction obliquely extend inwardly and downwardly from a lower portion of the movable plate.

8. The jig for assembling the connector assembly of claim 1, wherein
the pressed protrusion comprises a plurality of bulges which are integrally constructed on the corresponding side wall and are arranged front and rear as a column,
in the loading state, the pressing portions of the two movable plates press downwardly on the bulges of the two side walls of the guide shielding cage.

9. The jig for assembling the connector assembly of claim 8, wherein
the guide shielding cage further has a plurality of inserting legs which are positioned to a bottom edge of the corresponding side wall,
the plurality of bulges are positioned to a lower half portion of the corresponding side wall and are close to the plurality of inserting legs,
in the loading state, the pressing portions of the two movable plates press downwardly on the bulges of the two side walls of the guide shielding cage to make the inserting legs of the two side walls of the guide shielding cage downwardly inserted into a circuit board.

10. The jig for assembling the connector assembly of claim 1, wherein
the pressing cover has a front positioning piece which is integrally constructed to a front end of the pressing cover and extends downwardly and two side positioning pieces which are integrally constructed at two sides of the pressing cover, are close to the front end of the pressing cover and extend downwardly,
the front positioning piece is capable of being positioned at a front end of the guide shielding cage,
the two side positioning pieces are capable of being positioned at two sides of the heat sink.

11. The jig for assembling the connector assembly of claim 1, wherein
the movable plate further has a guiding block which extends inwardly from an inner side surface of the movable plate,
the pressing cover has an inner top surface and an inner boss which extends downwardly from the inner top surface, the inner boss has guiding grooves which are positioned to two sides of the inner boss and each accommodate the corresponding guiding block.
